(19) United States
(12) Patent Application Publication
(10) Pub. No.: US 2016/0047950 A1
(43) Pub. Date: Feb. 18, 2016

(54) DISPLAY DEVICE

(71) Applicant: HON HAI PRECISION INDUSTRY CO., LTD., New Taipei (TW)

(72) Inventor: SEI-PING LOUH, Tu-Cheng (TW)

(21) Appl. No.: 14/680,674

(22) Filed: Apr. 7, 2015

(30) Foreign Application Priority Data
Aug. 12, 2014 (TW) 103127689

(51) Int. Cl. G02B 3/08

(52) U.S. Cl. CPC G02B 3/08; G02B 2003/0093

(57) ABSTRACT

A display device includes a base, a display panel, a lens member, and a cover. The base includes a bottom plate and a sidewall perpendicularly extending from peripheral edges of the bottom plate. The sidewall includes an inner surface and an opposing outer surface. The display panel is received in the base and attached to the bottom plate. A gap is formed between the display panel and the inner surface. The lens member is attached to the inner surface and covers portions of the bottom plate corresponding to the gap. The lens member includes a bottom surface, an opposing light output surface, a first side surface, and an opposing second side surface. The first and second side surfaces are interconnected between the bottom surface and the light output surface. Striped protrusions are formed on the light output surface. The cover is supported on the base.

### FIELD

The subject matter herein generally relates to display technologies and, particularly, to a display device.

### BACKGROUND

Display devices are widely used in a variety of electronic devices, such as mobile phones, tablets, computers, etc. The display device includes a frame and defines a display area surrounded by the frame. Images output from the display device are shown in the display area.

### BRIEF DESCRIPTION OF THE DRAWINGS

Implementations of the present technology will now be described, by way of example only, with reference to the attached figures.

FIG. 1 is an isometric view of an exemplary embodiment of a display device.

FIG. 2 is an exploded view of the display device of FIG. 1.

FIG. 3 is an isometric view of a lens member of the display device of FIG. 2.

FIG. 4 is a cross sectional view of the lens member, taken along line IV-IV of FIG. 3.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described.

Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to mean essentially conforming to the particular dimension, shape, or other feature that is modified such that exactness does not apply. For example, substantially rectangular means that the object resembles a rectangle, but can have one or more deviations from a true rectangle. The term “comprising,” means “including, but not necessarily limited to” and specifically indicates open-ended inclusion or membership in the so-described combination, group, series and the like.

Embodiments of the present disclosure are described in relation to a display device. A display device includes a base, a display panel, a lens member, and a cover. The base includes a bottom plate and a sidewall perpendicularly extending from peripheral edges of the bottom plate. The sidewall includes an inner surface and an outer surface opposite to the inner surface. The display panel is received in the base and attached to the bottom plate. A gap is formed between peripheral sides of the display panel and the inner surface. The lens member is attached to the inner surface and covering portions of the bottom plate corresponding to the gap. The lens member includes a bottom surface, a light output surface opposite to the bottom surface, a first side surface, and a second side surface opposite to the first side surface. The first side surface and the second side surface are interconnected between the bottom surface and the light output surface. The first side surface and the second side surface are perpendicular to the bottom surface. A number of striped protrusions are formed on the light output surface. The cover is supported on the base and includes a display portion and an extension portion. The display portion is positioned above the display panel and aligned with the display panel. The extension portion surrounds the display portion and is aligned with the lens member.

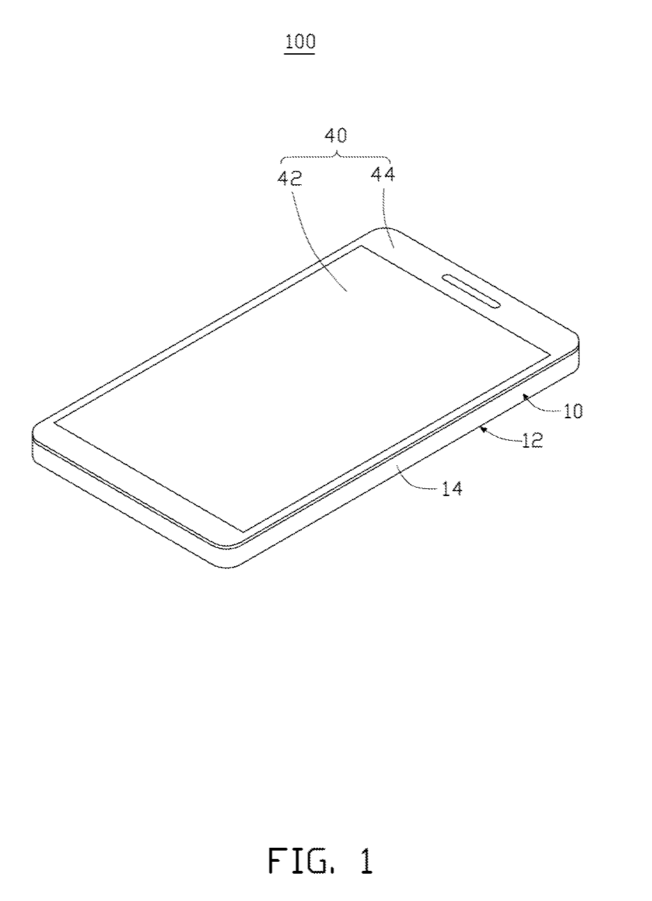

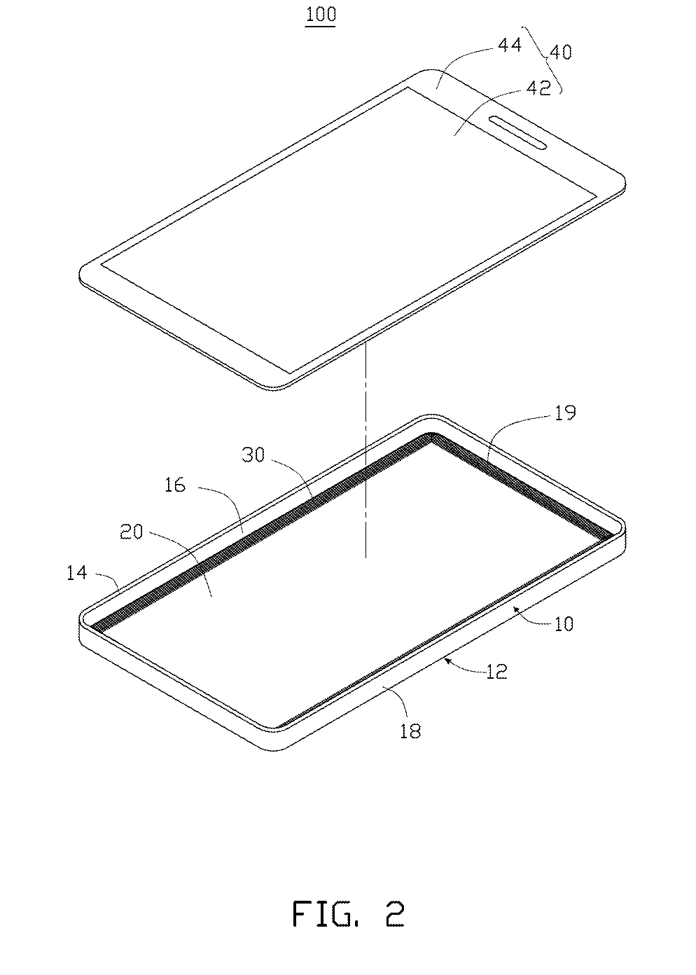

FIGS. 1 and 2 illustrate an exemplary embodiment of a display device 100. The display device 100 includes a base 10, a display panel 20, a lens member 30, and a cover 40.

The base 10 is configured to receive the display panel 20 and the lens member 30, and to support the cover 40. The base 10 is substantially rectangular, and includes a bottom plate 12, and a ring-shaped sidewall 14. The bottom plate 12 is substantially rectangular. The sidewall 14 perpendicularly extends from four peripheral edges of the bottom plate 12. The sidewall 14 includes an inner surface 16 and an outer surface 18. The inner surface 16 and the outer surface 18 are positioned at opposite sides of the sidewall 14, and the inner surface 16 is substantially parallel to the outer surface 18.

The display panel 20 is substantially rectangular. The display panel 20 is received in the base 10 and is attached to the bottom plate 12. A gap 19 is formed between four peripheral sides of the display panel 20 and the inner surface 16.

FIGS. 2-4 illustrate that the lens member 30 is substantially ring-shaped conforming to the sidewall 14. The lens member 30 includes a bottom surface 32, a light output surface 34, a first side surface 36, and a second side surface 38. The bottom surface 32 is a flat plane.

The bottom surface 32 and the light output surface 34 are positioned at opposite sides of the lens member 30. The first side surface 36 and the second side surface 38 are positioned at opposite sides of the lens member 30, and the first side surface 36 is substantially parallel to the second side surface 38. The first side surface 36 and the second side surface 38 are interconnected between the bottom surface 32 and the light output surface 34. The first side surface 36 and the second side surface 38 are substantially perpendicular to the bottom surface 32. The first side surface 36 is attached to and fixed to the inner surface 16, and the lens member 30 covers the gap 19 and is spaced apart from the bottom plate 12. In other embodiments, the bottom surface 32 is attached to the bottom plate 12.

A number of striped protrusions 35 are formed on the light output surface 34. The protrusions 35 are ring-shaped conforming to the lens member 30. In this embodiment, the protrusions 35 and the lens member 30 are formed into a unit. A cross section of each of the protrusions 35 is substantially a triangle along a direction perpendicular to the bottom plate 12 and the inner surface 16. Each of the protrusions 35 includes a first slanted surface 352 and a second slanted surface 354 obliquely connecting to the first slanted surface 352. An included angle a between the first slanted surface 352 and the bottom surface 32 is in a range from 60 degrees to 80 degrees, and an included angle β between the second slanted surface 354 and the bottom surface 32 is about 89 degrees.

FIGS. 1-2 illustrates that the cover 40 includes a display portion 42 and an extension portion 44. The cover 40 is supported on the base 10. In detail, the display portion 42 is positioned above the display panel 20 and is aligned with the display panel 20. The extension portion 44 surrounds the display portion 42 and is aligned with the lens member 30. The cover 40 is made of transparent material, such as glass, or polymethyl methacrylate (PMMA).

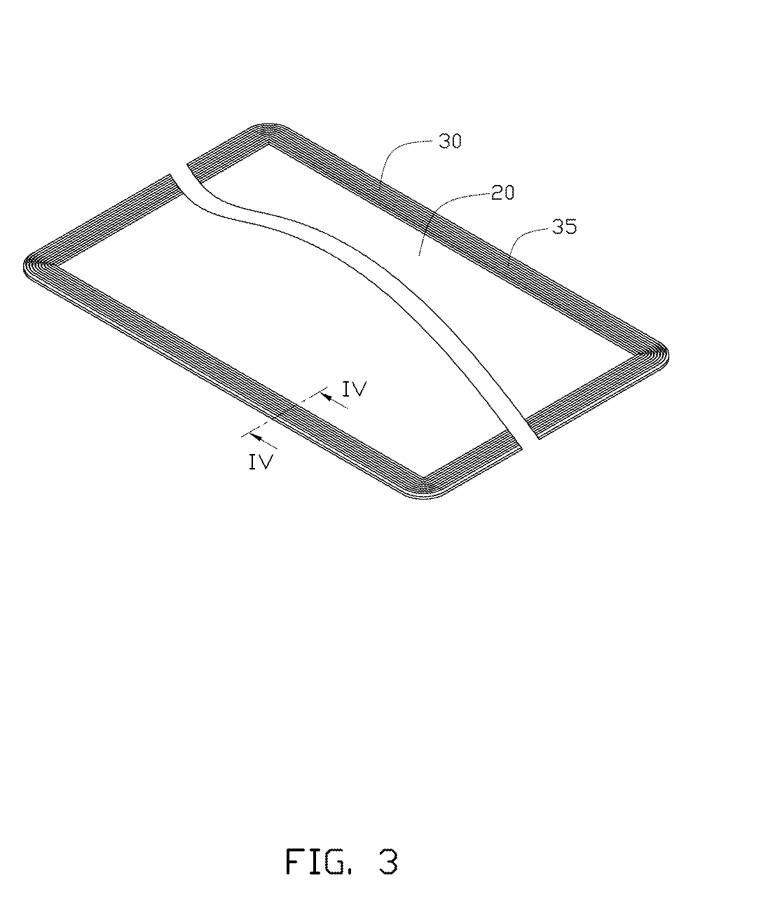

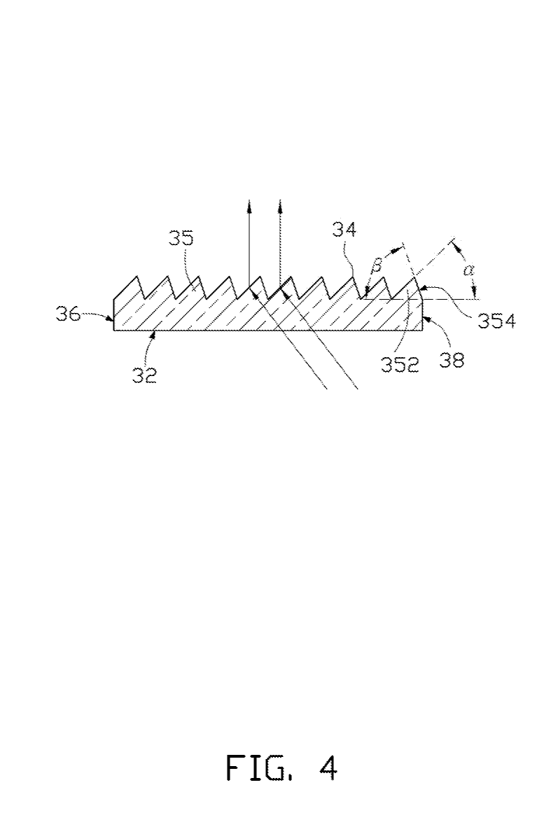

FIGS. 3-4 illustrates that when light from the display panel 20 first enters the lens member 30 through the bottom surface 22, and then refracts and exits out of the lens member 30 through the light output surface 34, and finally emits out of the display device 400 from the extension portion 44. Therefore, a viewer can see images from the whole cover 40, including the display portion 42 and the extension portion 44. In other words, the area of the display device 100 showing images becomes wider.

The embodiments shown and described above are only examples. Many details are often found in the art such as the other features of a display device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in the matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A display device comprising:
a base comprising a bottom plate and a sidewall perpendicularly extending from peripheral edges of the bottom plate, the sidewall comprising an inner surface and an outer surface opposite to the inner surface;
a display panel received in the base and attached to the bottom plate, a gap formed between peripheral sides of the display panel and the inner surface;
a lens member attaching to the inner surface and covering portions of the bottom plate corresponding to the gap, the lens member comprising a bottom surface, a light output surface opposite to the bottom surface, a first side surface, and a second side surface opposite to the first side surface, the first side surface and the second side surface interconnected between the bottom surface and the light output surface, the first side surface and the second side surface being perpendicular to the bottom surface, a plurality of striped protrusions formed on the light output surface; and
a cover supported on the base and comprising a display portion and an extension portion, the display portion positioned above the display panel and aligned with the display panel, and the extension portion surrounding the display portion and aligned with the lens member.

2. The display device of claim 1, wherein the first side surface is attached to and fixed to the inner surface, and the light output surface faces away the display panel.

3. The display device of claim 1, wherein the bottom surface is a flat plane, and the bottom surface is spaced apart from the bottom plate.

4. The display device of claim 1, wherein the bottom surface is attached to the bottom plate.

5. The display device of claim 1, wherein the protrusions and the lens member are formed into a unitary.

6. The display device of claim 1, wherein a cross section of each of the protrusions is substantially a triangle along a direction perpendicular to the bottom plate and the inner surface.

7. The display device of claim 6, wherein each of the protrusions includes a first slanted surface and a second slanted surface obliquely connecting to the first slanted surface, an included angle between the first slanted surface and the bottom surface is in a range from 60 degrees to 80 degrees, and an included angle between the second slanted surface and the bottom surface is about 89 degrees.

8. The display device of claim 1, wherein the cover is made of transparent material.

9. A display device comprising:
a base having:
a bottom plate with a first side edge, a second side edge opposite, and substantially parallel, to the first side edge, a third edge substantially perpendicular to the first side edge and the second side edge, and a fourth side edge opposite, and substantially parallel, to the third edge;
a first side wall extending from the first side edge substantially perpendicular to the bottom plate, the first side wall having an inner surface facing the bottom plate and an outer surface opposite the inner surface;
a second side wall extending from the second side edge substantially perpendicular to the bottom plate, the second side wall having an inner surface facing the bottom plate and an outer surface opposite the inner surface;
a third side wall extending from the third side edge substantially perpendicular to the bottom plate, the third side wall having an inner surface facing the bottom plate and an outer surface opposite the inner surface; and
a fourth side wall extending from the fourth side edge substantially perpendicular to the bottom plate, the fourth side wall having an inner surface facing the bottom plate and an outer surface opposite the inner surface;
wherein, the bottom plate, the first side wall, the second side wall, the third side wall and the fourth side wall cooperate to form a defined receiving space;
a display panel received into the receiving space and positioned to form a gap between the display panel and the inner surfaces of the side walls;
a lens member attached to the inner surface of the side walls and positioned to cover the gap between the display panel and the sides walls; and
a cover attached to the base and having a display portion and an extension portion;
wherein, the display panel is positioned between the cover display portion and the bottom plate and the lens member is positioned between the cover extension portion and the bottom plate;
wherein, the lens member has a bottom surface facing the bottom plate, a light output surface opposite the bottom surface and facing the cover extension portion;
wherein, the lens member includes a first portion adjacent the first side wall, a second portion adjacent the second side wall, a third portion adjacent the third side wall and a fourth portion adjacent the fourth side wall; and
wherein, a plurality of striped protrusions are formed on the lens member light output surface with the striped protrusions of the first lens member portion being substantially parallel to the first side wall, the striped protrusions of the second lens member portion being substantially parallel to the second side wall, the striped protrusions of the third lens member portion being substantially parallel to the third side wall and the striped protrusions of the fourth lens member portion being substantially parallel to the fourth side wall.
